(19) United States
(12) Patent Application Publication
(10) Pub. No.: US 2009/0223342 A1
(43) Pub. Date: Sep. 10, 2009

(54) CIRCULAR SAW BLADE WITH CLEARING EDGES AND A PROCESS FOR MANUFACTURING CLEARING EDGES

(76) Inventor: Bernhard Humpf, Unterschneidheim (DE)

Correspondence Address: GREENBLUM & BERNSTEIN, P.L.C., 1950 ROLAND CLARKE PLACE, RESTON, VA, 20191, US

(21) Appl. No.: 12/297,326

(22) PCT Filed: Apr. 27, 2007
(86) PCT No.: PCT/DE07/00783

§ 371 Date: Nov. 13, 2008

(30) Foreign Application Priority Data
May 4, 2006 (DE) 10 2006 021 136.7

(51) Int. Cl. B23D 61/02; B23D 65/00

(52) U.S. Cl. 83/835; 83/676; 76/112

(57) ABSTRACT

The invention relates to a circular saw blade comprising a support body (1) and a plurality of cutting teeth (2) distributed over the circumference, in which the support body (1) has a plurality of material recesses (3) that in some areas have clearing edges (4) that project axially beyond the support body (1), which is characterized in that the clearing edges (4) are embodied in one piece with the support body (1).

The invention relates to a circular saw blade, comprising a support body and a plurality of cutting teeth distributed over the circumference, in which the support body has a plurality of material recesses that in some areas have clearing edges that project axially beyond the support body, and a method for producing the clearing edges.

A circular saw blade of this type is known, for example, from DE 20 2005 006 613 U1. The clearing edges project axially beyond the support body of the circular saw blade and promote the chip disposal when cutting into wood.

In particular in the processing of rough timber in saw mills, relatively long wood shavings occur. These long wood shavings are transported away from the sawing kerf only to an unsatisfactory extent with conventional saw blades without clearing edges. This can mean that the cutting gap becomes clogged, whereby the friction is increased and the high temperature developing as a result can lead to the destruction of the circular saw blade.

For better removal of the wood shavings from the cutting gap, the so-called clearing edges are provided on the circular saw blade, which ensure that even long wood shavings are transported away from the cutting gap. These clearing edges are arranged in material recesses of the saw blade and can be embodied with a flat front surface. The clearing edges can have different lengths.

U.S. Pat. No. 3,521,684 discloses a circular saw blade with clearing edges of hard metal, which are attached to the saw blade by rivets.

DE 199 47 638 A1, DE 299 17 369 U1 and DE 31 19 603 A1 show circular saw blades with clearing edges, in which the clearing edges are soldered onto the saw blade.

DE 201 11 424 U1 describes a circular saw blade with profiled clearing edges that can be attached to the circular saw blade by soldering, gluing or riveting or by threaded connections.

DE 20 2005 001 714 U1 discloses a circular saw blade with short clearing edges, which extend further to the center of the saw and the sawtooth gullets extend to the front of the short clearing edges.

From DE 20 2005 001 719 U1 a circular saw blade with clearing edges is known, in which the clearing edges have a relief angle of at least 10°.

DE 101 16 092 A1 and DE 201 05 630 U1 describe circular saw blades that have a reduced spacing of the cutting elements on the tooth face and the outer ends of the clearing edges.

DE 297 20 155 U1 discloses a circular saw blade with clearing edges, which has tapers in the thickness of the saw blade in the area in front of and/or behind the clearing edges.

The known clearing edges comprise a different material than the support body of the circular saw blade and have to be attached to the circular saw blade in a complex process step, for example, by soldering or riveting of hard metal bars or screwing on cutting edges of other tool steels.

The attachment of the clearing edges to the material recesses must be carried out very carefully, so that during the operation of the circular saw blade no safety risk to the worker can occur by clearing edges detaching from the carrier material of the circular saw blade and injuring the machine operator. The methods for attaching the cutting edges to the material recesses are therefore correspondingly complex and are subject to strict quality controls. Moreover, after the attachment of the clearing edges, a subsequent stress-relief annealing of the saw blade and a defined grinding of the lateral overhang of the cutting edges optionally provided with a relief angle must be carried out. It is also a disadvantage that stresses develop in the saw blade through the different temperature coefficients of expansion of the saw blade and the cutting edges, which stresses can have an unfavorable effect on the cutting quality.

Moreover, in particular hard metal clearing edges are limited to straight shapes so that they can be attached to the support body sufficiently firmly by a soldered connection. However, it can be necessary for the optimal clearing of the kerfs for other shapes of clearing edges to be more advantageous. Furthermore, with the attachment by soldering or riveting, a certain minimum support body thickness is necessary. With a support body thickness that is too low at less than 1 mm, a sufficient strength of the soldered connection can no longer be achieved. Moreover, an increased deformation with small saw-blade body thickness is to be anticipated. This is problematic in particular with the thin-cut saws for reducing the cutting gap or the amount of waste.

Based on this problem, the circular saw blade described at the outset is to be improved in order to achieve a reduction of the width of cut, a better chip discharge with a lower heating of the support body and at the same time a longer tool life with reduced production costs.

The object is attained according to the invention in that the clearing edges are embodied in one piece with the support body.

Embodied in one piece with the support body means that the support body has a local thickening to form the clearing edge. These can be formed from the support body by shaping the saw-blade body material.

It is advantageously possible hereby to embody clearing blades deviating from their straight shape in any desired form, thus optimizing them in their functionality for their function of conveying chips out of the cutting gap. Moreover, the principle of the clearing edges can also be used with very thin saw-blade bodies (<1 mm), with which soldering is not possible. The stabilizing effect can be achieved with this embodiment of the clearing blades in that the material is hardened and strengthened during the shaping. The thickened areas of the saw-blade body that act as clearing blades can be produced either directly to finished size by shaping or with an allowance and conventionally ground subsequently. A plastic deformation of the support body material can be carried out through a shaping method, advantageously a hot-working method.

The material recesses in which clearing edges are embodied can advantageously have a closed circumferential contour or have openings emerging radially from the support body. In this manner, material recesses and clearing edges can be distributed in the support body in a manner that renders possible an optimal cutting quality.

In order to increase the tool life of the circular saw blade, the area of the clearing edges can have a greater hardness than the remaining support body. To this end, an alloy of a more highly alloyed steel can be applied onto the area in which the clearing edges are provided. It has been shown that the elements of the subgroups IV to VIII of the periodic system of the elements are particularly suitable for this purpose. The application of the alloy can be carried out in the form of an alloyed powder that is placed on the support body of the circular saw blade for the hot working process, and during the hot working process is fused onto the surface of the support body and onto the area of the clearing edges.

The width of the clearing edges should be adjusted such that it is wider than the thickness of the support body and thinner than the width of the cutting tooth so that a optimal clearing of the kerf can be carried out.

Moreover it is advantageous for the circular saw blade according to the invention to have clearing edges that can run in a straight line as well as in an arched manner or along a free-form contour. It is thus possible to embody the clearing edges for an optimal clearing of the kerf without having to take the producibility into consideration.

The clearing edges are provided in the rear area of the material recesses in the direction of rotation of the saw blade, so that the optimal clearing of the kerf can be carried out.

To solve the problem, a method for production of a circular saw blade is characterized by the following steps:
1. Insertion of a rotating pressure pin of a heat-resisting material into a material recess of the support body,
2. Pressing the pressure pin against a wall of the support body formed by the material recess,
3. Local heating of the support body by the frictional heat of the rotating pressure pin and
4. Movement of the pressure pin along the wall formed by the material recess so that the material of the support body is plastically deformed and a clearing edge is formed.

Through the movement of the pressure pin along the wall of the support body formed by the material recess in the area in which the clearing edge is provided, the clearing edge is formed in one piece from the support body of the circular saw blade by means of a hot-working process. Advantageously, a compression of the support body material and thus a hardening of the clearing edge hereby occur. This method is very simple to carry out, since the heat for shaping is generated locally through friction of the rotating pressure pin, and the pressure pin is pressed against the saw blade body material until it is deformed. Another increased hardening occurs because the plastically deformed point can cool rapidly.

Advantageously, the pressure pin can have a groove of a defined width that is adjusted such that it corresponds to the width of the clearing edge to be produced. In this manner a clearing edge of a defined width can be produced very simply. An extensive regrinding of the clearing blade is usually not necessary here. The clearing edges can be produced directly to finished size. It is also possible to produce the clearing edges with an allowance and to grind them to the finished size.

Through the rapid cooling of the heated area in air and due to the heat removal into the surrounding support body, the cold saw-blade body, an increased hardening of the shaped area can be produced, which has a positive effect on the stiffness of the saw blade.

Advantageously, the pressure pin comprises a heat-resistant material, e.g., hard metal, so that only the carrier material is deformed and not the pressure pin. The frictional heat that is to be achieved through the rotating pressure pin in the area of the material recesses should be so high that the carrier material can be softened. It has been shown that temperatures of over 700° C. can be generated through the friction between carrier material and pressure pin. A particularly precise one-piece shaping of the clearing edge from the carrier blade material can be carried out through the local heating of the support body.

To further increase the hardness of the clearing edges, an alloyed powder can be applied to the carrier material, which powder is fused together with the carrier material through the local heating and renders possible an even harder clearing edge.

Exemplary embodiments of the invention are explained in more detail below based on a drawing. They show

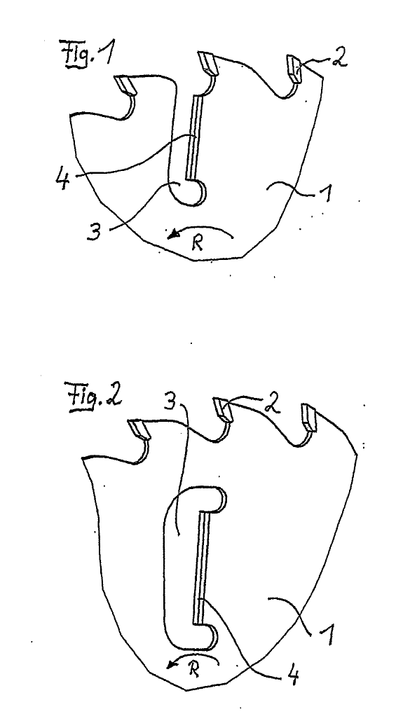

FIG. 1: A partial plan view of a first circular saw blade with clearing edges embodied in one piece;

FIG. 2: A partial plan view of another circular saw blade with clearing edges embodied in one piece;

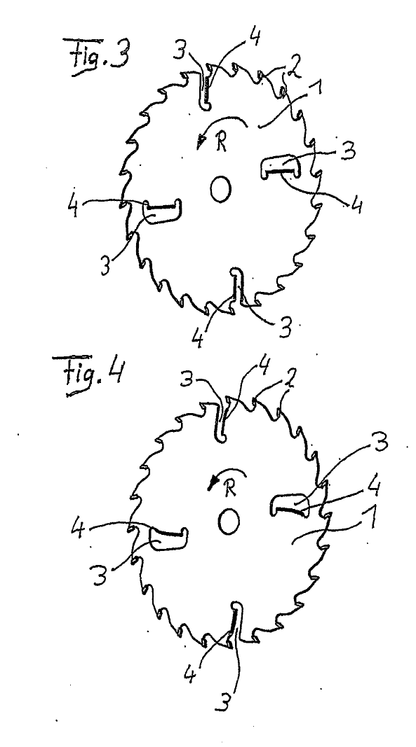

FIG. 3: A perspective view of another circular saw blade with clearing edges embodied in one piece, which clearing edges run in a straight line;

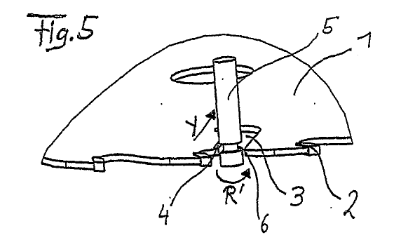

FIG. 4: A perspective view of another circular saw blade with clearing edges embodied in one piece, which clearing edges run in an arched manner and

FIG. 5: A partial view of a circular saw blade that is deformed with a pressure pin.

FIG. 1 shows a circular saw blade with a support body 1, which has a plurality of cutting teeth 2 distributed over the circumference. A plurality of material recesses 3 is provided in the support body 1, which have openings emerging radially from the support body 1. Clearing edges 4 are provided in the rear area of the material recesses 3 in the rotational direction R of the saw blade. The clearing edges 4 are embodied in one piece with the support body 1. To embody the clearing edges 4, a pressure pin 5 is guided along an area of the material recess 3 in a hot shaping process so that a plastic deformation of the support body 1 is achieved and a clearing edge 4 is produced (cf. FIG. 5). During the hot shaping process to produce the clearing edge 4 an alloyed powder of metal that has a higher hardness than the support body material is applied to the area of the material recess 3 from which the clearing blade 4 is formed and alloyed over the pressure pin 5 onto the support body material.

FIG. 2 shows a circular saw blade with a support body 1 and cutting teeth 2, in which the material recesses 3 have a closed circumferential contour, that is, are completely enclosed by the support body 1. In the rear section of the material recess 3 of the saw blade in the rotational direction R, the clearing edge 4 is embodied in one piece with the support body 1 of the circular saw blade. The clearing edge 4 has a shape running in a straight line. The width of the clearing edge 4 is greater than the thickness of the support body 1 and smaller than the width of the cutting teeth 2.

FIG. 3 shows a circular saw blade with a support body 1, which has a plurality of cutting teeth 2 distributed over the circumference. A plurality of material recesses 3 are discernible in the support body 1, which recesses have openings emerging radially from the support body 1 or are completely enclosed by the support body 1. Clearing edges 4 are provided in the rear section of the material recesses 3 of the saw blade in the rotational direction R, which clearing edges run in a straight line and are embodied in one piece with the support body 1.

FIG. 4 shows another circular saw blade with a support body 1 and cutting teeth 2 in which the material recesses 3 emerge radially from the support body 1 or are completely enclosed by the support body 1. Clearing edges 4 running in an arched manner are embodied in one piece with the support body 1 in the rear area of the material recesses 3 in the rotational direction R of the circular saw blade.

FIG. 5 shows another circular saw blade with a support body 1 and cutting teeth 2 in which a pressure pin 5 rotating in the rotational direction R′ is inserted into a material recess 3 and pressed against the support body 1. The support body 1 is locally heated through the rotational movement of the pressure pin 5 such that the material of the support body 1 becomes soft and through further pressing of the pressure pin 5 against the support body 1 in the area of the material recess 3 flows into the groove 6 of the pressure pin 5. The pressure pin 5 comprises hard metal. The rotating pressure pin 5 is guided optionally with contact pressure along the material recess 3 and causes the deformation of the support body material due to the local heating of the support body material, whereby, after the subsequent cooling of the support body material, the clearing edge 4 embodied in one piece with the support body 1 is produced. The rotating pressure pin 5 is moved in the feed direction Y along the material recess 3. An increased hardening of the shaped area with the clearing edge 4 is achieved through the rapid cooling of the heated area in air and due to the heat removal into the surrounding cold support body material. The stiffness of the saw blade is improved thereby.

### LIST OF REFERENCE NUMBERS

1 Support body
2 Cutting tooth
3 Material recess
4 Clearing edge
5 Pressure pin
6 Groove
R Rotational direction
R′ Rotational direction
Y Feed direction

1. A circular saw blade, comprising a support body and a plurality of cutting teeth distributed over the circumference, in which the support body has a plurality of material recesses that in some areas have clearing edges that project axially beyond the support body, the clearing edges being embodied in one piece with the support body.

2. The circular saw blade according to claim 1, wherein the clearing edges are produced by plastic deformation of the support body material.

3. The circular saw blade according to claim 2, wherein the clearing edges are produced by a hot-working process.

4. The circular saw blade according to claim 1, wherein the material recesses have a closed circumferential contour.

5. The circular saw blade according to claim 1, wherein the material recesses have openings emerging radially from the support body.

6. The circular saw blade according to claim 1, wherein the area of the clearing blades has a greater hardness than the remaining support body.

7. The circular saw blade according to claim 1, further comprising an alloy of a more highly alloyed steel is applied onto the area of the clearing edges.

8. The circular saw blade according to claim 7, wherein elements of the subgroups IV to VIII of the periodic system of the elements are added to the alloy.

9. The circular saw blade according to claim 7, wherein the application of the alloy is carried out in the form of an alloyed powder.

10. The circular saw blade according to claim 1, wherein the clearing blades lie in a rear area of the material recesses in a rotational direction R of the saw blade.

11. The circular saw blade according to claim 1, wherein the clearing edges have an arched contour.

12. A method for producing a circular saw blade comprising:
insertion of a rotating pressure pin of a heat-resisting material into a material recess of a support body,
pressing the pressure pin against a wall of the support body formed by the material recess,
local heating of the support body by frictional heat of the rotating pressure pin, and
movement of the pressure pin along a wall formed by the material recess so that the material of the support body is plastically deformed and a clearing edge is formed.

13. The method according to claim 12, wherein the pressure pin has a groove with a width, the width of which corresponds to a width of the clearing edge to be produced.

14. The method according to claim 12, further comprising applying an alloyed powder to the support body in the area of the material recess.

15. The method according to claim 12, further comprising hardening the clearing edge.
